(19) United States
(12) Patent Application Publication
(10) Pub. No.: US 2020/0354154 A1
(43) Pub. Date: Nov. 12, 2020

(54) AGRICULTURAL DEVICE FOR TRANSFERRING SEED OR GRAIN

(71) Applicant: J. & M. Manufacturing Co., Inc., Ft. Recovery, OH (US)

(72) Inventor: Alex Grieshop, Ft. Recovery, OH (US)

(21) Appl. No.: 16/857,277

(22) Filed: Apr. 24, 2020

Related U.S. Application Data
(60) Provisional application No. 62/844,350, filed on May 7, 2019.
(60) Provisional application No. 62/893,320, filed on Aug. 29, 2019.

(51) Int. Cl. B65G 33/14; A01D 90/10

(52) U.S. Cl. CPC B65G 33/14; B65G 2201/042; A01D 90/10

(57) ABSTRACT

An agricultural seed or grain transferring device includes a transport tube supported at an inclined angle to define a closed, lower end and an upper end. An auger extends between the closed, lower end and the upper end of the transport tube. A motorized drive unit rotates the auger. An inlet opening in the transport tube is located proximate the closed, lower end and an outlet opening in the transport tube is located proximate the upper end. The auger includes a first end portion including at least a portion of an auger blade extending between the inlet opening and the closed, lower end of the transport tube.

### CROSS-REFERENCE TO RELATED APPLICATION

This application claims the benefit of U.S. Provisional Patent Application Ser. No. 62/844,350, filed May 7, 2019, and, U.S. Provisional Patent Application Ser. No. 62/893,320, filed on Aug. 29, 2019, the disclosures of which are incorporated herein by reference in their entirety.

### BACKGROUND

The present invention generally relates to agricultural apparatus for transferring seed or grain and, more particularly, to apparatus configured to transfer seed or grain through a tube using an internally mounted auger.

Seed carts and seed tenders are used in the agricultural industry for transporting seed and grain to and from the field. Equipment of this type may be used during harvest or during planting. In each case, it is desirable to keep damage to the seed or grain to a minimum, but this is especially important during the planting season. Conveyors, of either the belt type or auger type may be used to transport seed and grain. Generally, belt type conveyors are seen as less prone to damaging the seed and grain than auger type conveyors. But, the use of belt type conveyors comes with trade-offs, including a slower rate of seed/grain transfer.

Many farmers prefer to use belt type conveyors to transfer seed to planters during the planting season because seed is expensive. The expense may be enhanced due to the addition of herbicides and/or pesticides, or other modifications to the seed. Many farmers may use auger type conveyors during harvest to increase production volume and because damage is not as high a concern during harvest in many cases. For these reasons, farmers may own or otherwise use both belt type and auger type seed and grain transferring devices during the year.

The present disclosure contemplates that, in some conventional auger type conveyors, damage to the seed or grain may occur in locations where the rotating auger crushes or grinds the seed or grain against the interior of the transport tube in which the auger is mounted. For example, the present disclosure contemplates that seed or grain may be damaged near the upstream end of an auger type conveyer where the seed or grain may be crushed or ground between the rotating, upstream end of the auger and the stationary, upstream end of the transport tube.

It would be beneficial to provide an auger type seed or grain transport device which results in reduced seed or grain damage during use, especially during planting seasons, while still being useful in all situations in which a farmer may desire to transfer seed and grain at higher volumes.

### SUMMARY

In a first illustrative embodiment an agricultural seed or grain transferring device comprises a transport tube, an auger mounted for rotation within the transport tube. More specifically, the transport tube is supported at an inclined angle to define a closed, lower end and an upper end. The auger extends between the lower end and the upper end of the transport tube. An inlet opening in the transport tube is located proximate the closed, lower end and an outlet opening in the transport tube is located proximate the upper end. The auger includes a first end portion including at least a portion of an auger blade extending between the inlet opening and the closed, lower end of the transport tube.

The device may include additional and/or alternative features. For example, the inlet opening may further comprise an elongate opening extending along a lengthwise axis of the transport tube and at least one auger blade of the auger may be positioned between a lower edge of the inlet opening and the closed, lower end of the transport tube. The length of the inlet opening may extend along at least two auger blades. The inlet opening may be located in the lower third portion of the transport tube. The auger may include a second end located opposite to the first end portion, and the outlet opening may be located beyond the second end of the auger. The device may include a motorized drive unit coupled to the auger for rotating the auger. The motorized drive unit may be positioned at the lower end of the transport tube and is coupled to the auger for rotating the auger. The motorized drive unit may be driven by at least one of a hydraulic motor, an internal combustion engine, and an electric motor.

In another aspect, a method of transferring seed or grain is provided and generally comprises:

delivering the seed or grain into a lower end portion of a transport tube supported at an inclined angle to define a closed, lower end and an upper end, the seed or grain being delivered through an inlet opening in the transport tube proximate the closed, lower end,

rotating an auger mounted within the transport tube and extending between the lower end and the upper end of the transport tube to move the seed or grain from the inlet opening toward the upper end of the transport tube, wherein the auger includes a first end portion having a length extending between the inlet opening and the closed, lower end of the transport tube, and directing the seed or grain through an outlet opening located proximate the upper end of the transport tube.

The method may also include additional and/or alternative features. For example, the inlet opening may further comprise an elongate opening extending along a lengthwise axis of the transport tube and at least one auger blade of the auger may be positioned between a lower edge of the inlet opening and the closed, lower end of the transport tube. Moving the seed or grain further may comprise using auger blades abutting the inlet opening and above the inlet opening to move the seed or grain within the transport tube toward the upper end. The length of the inlet opening may extend along at least two auger blades, and moving the seed or grain may further comprise initially moving the seed or grain with the at least two auger blades abutting the inlet opening. The inlet opening may be located in the lower third portion of the transport tube, and the auger may include a second end located opposite to the first end portion. The outlet opening may be located above the second end of the auger, and the method may further comprise directing the seed or grain through the outlet opening at a location beyond the second end of the auger.

In another embodiment, an agricultural seed or grain transferring device includes a transport tube including an upstream, lower end and a downstream, upper end; an auger mounted for rotation within the transport tube, the auger including blades having a pitch length; and an inlet opening in the transport tube proximate the lower end of the transport tube and an outlet opening in the transport tube proximate the upper end of the transport tube. The auger includes an auger upstream portion extending from an upstream, lower end of the inlet opening to an upstream, lower end of the auger, the auger upstream portion having an auger upstream portion axial length.

In alternative or additional aspects, the auger upstream portion axial length may be at least about ⅔ of the pitch length, at least about 75% of the pitch length, at least about 90% of the pitch length, about equal to the pitch length, and/or at least about equal to the pitch length. The auger upstream portion may be disposed within a transport tube upstream portion that extends from the upstream, lower end of the inlet opening to the lower end of the transport tube, the transport tube upstream portion having a transport tube upstream portion axial length. The transport tube upstream portion axial length may be at least about ⅔ of the pitch length and/or at least about 90% of the pitch length. The inlet opening may have an inlet opening axial length that is at least about twice the pitch length. The lower end of the auger may be positioned at the lower end of the transport tube. The lower end of the transport tube may be substantially closed. The auger may include a second end located opposite to the lower end of the auger, and the outlet opening of the transport tube may be located downstream beyond the second end of the auger. The transport tube may be configured to be supported at an inclined angle. The device may include a motorized drive unit coupled to the auger for rotating the auger. The motorized drive unit may be driven by at least one of a hydraulic motor, an internal combustion engine, and an electric motor.

In another embodiment, an agricultural seed or grain transferring device includes a transport tube including an upstream, lower end and a downstream, upper end; an auger mounted for rotation within the transport tube, the auger including blades having a pitch length; and an inlet opening in the transport tube proximate the lower end of the transport tube and an outlet opening in the transport tube proximate the upper end of the transport tube. The transport tube includes a transport tube upstream portion extending from an upstream, lower end of the inlet opening to the lower end of the transport tube, the transport tube upstream portion having a transport tube upstream portion axial length.

In alternative or additional aspects, the transport tube upstream portion axial length may be at least about ⅔ of the pitch length, at least about 90% of the pitch length, and/or at least about equal to the pitch length. The auger may include an auger upstream portion extending within the transport tube upstream portion from the upstream, lower end of the inlet opening to an upstream, lower end of the auger. The auger upstream portion may have an auger upstream portion axial length that is at least about ⅔ of the pitch length, at least about 90% of the pitch length, and/or at least about equal to the pitch length.

In another embodiment, a method of manufacturing an agricultural seed or grain transferring device includes constructing a transport tube including an upstream, lower end, a downstream, upper end, an inlet opening proximate the lower end, and an outlet opening proximate the upper end; rotatably mounting an auger within the transport tube, the auger including blades having a pitch length, the auger including an auger upstream portion extending from an upstream, lower end of the inlet opening to an upstream, lower end of the auger, the auger upstream portion having an auger upstream portion axial length.

In alternative or additional aspects, the auger upstream portion axial length may be at least about ⅔ of the pitch length and/or at least about 90% of the pitch length. The rotatably mounting the auger operation may include positioning the auger upstream portion within a transport tube upstream portion that extends from the upstream, lower end of the inlet opening to the lower end of the transport tube, the transport tube upstream portion having a transport tube upstream portion axial length. The rotatably mounting the auger operation may include positioning the auger upstream portion within the transport tube upstream portion, the transport tube upstream portion axial length being at least about ⅔ of the pitch length. The rotatably mounting the auger operation may include positioning the auger upstream portion within the transport tube upstream portion, the transport tube upstream portion axial length being at least about 90% of the pitch length.

Additional aspects and advantages of the invention will become more apparent upon further review of the detailed description of the illustrative embodiments taken in conjunction with the accompanying drawings.

### BRIEF DESCRIPTION OF THE DRAWINGS

FIG. 1 is a perspective view of an agricultural seed or grain transferring device constructed in accordance with an illustrative embodiment.

FIG. 2 is a cross-sectional view of the device shown in FIG. 1, taken generally along a lengthwise central axis of the transport tube.

FIG. 2A is a cross-sectional view similar to FIG. 2, and further illustrating a connection of the transferring device to a seed or grain cart.

FIG. 3A is an enlarged view of a portion of FIG. 2, illustrating the lower portion of the transport tube, auger and drive coupling as well as the inlet opening of the transport tube.

FIG. 3B is a cross-sectional view similar to FIG. 3A, but illustrating the introduction and movement of seed or grain from the inlet opening upward along the auger and transport tube.

FIG. 4 is an enlarged cross-sectional view shown in perspective to illustrate components of the device at the inlet end portion.

### DETAILED DESCRIPTION

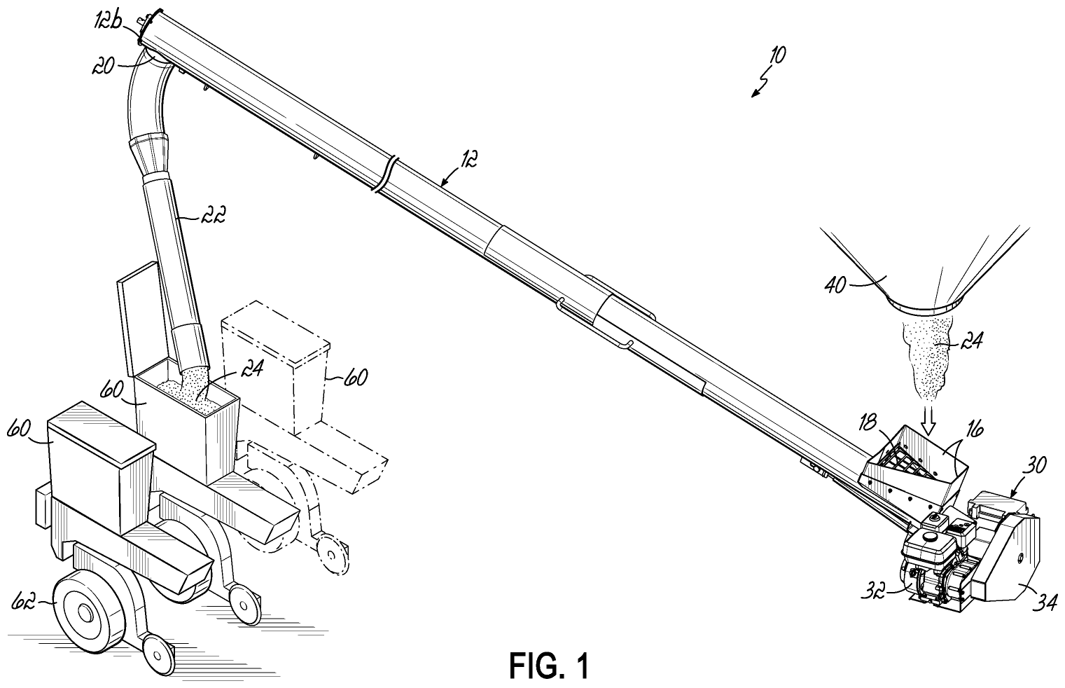

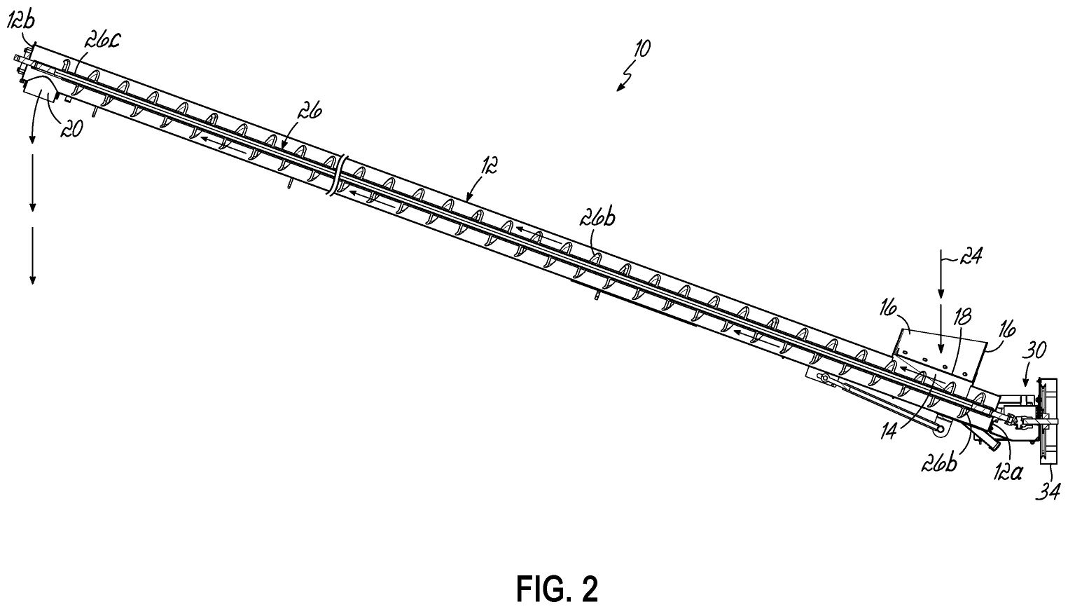

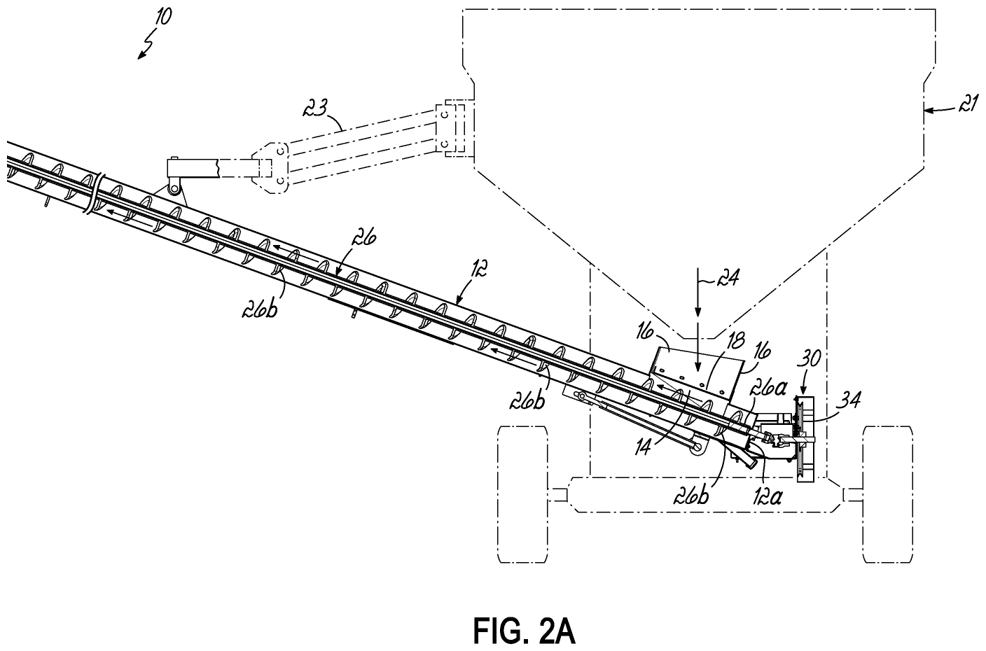

Referring to FIGS. 1, 2 and 2A an illustrative embodiment of an agricultural seed or grain transferring device 10 is shown and comprises a transport tube 12 having an inlet opening 14. The inlet opening 14 is surrounded by upstanding panels 16 fixed to the transport tube 12 and a grate 18 covers the opening 14. An opposite end of the transport tube 12 includes an outlet opening 20 coupled with an outlet tube, which may be a flexible conduit 22. As illustrated, the transport tube 12 is mounted at an inclined angle, which may be for example, between 15° and 45° relative to horizontal. The device 10 may be a freestanding unit 10, for example, so that it may be used in multiple situations. Or, the device 10 may be part of other agricultural equipment, such as a cart, tank, etc. FIG. 2A illustrates the device 10 coupled to a seed or grain cart 21 by a support arm 23. The inlet opening 14 is proximate the lower end 12a (which may be partially or substantially closed, such as by an end wall), while the outlet opening 20 is proximate the upper end 12b (which may be partially or substantially closed, such as by an end wall) of the transport tube 12.

Seed or grain 24 is delivered through the inlet opening 14 and onto an auger 26 mounted for rotation within the transport tube 12, as illustrated in FIG. 2. The auger 26 is generally in the form of a helix disposed around a central, axial shaft and including blades 26b, which may be provided as continuous flighting or a series of sectional flights. A drive unit 30, including a motor 32 coupled with a drive or transmission 34 is operatively coupled to a lower end of the auger 26. Various embodiments may be driven by motors including internal combustion engines, electric motors, or hydraulic motors, for example. An upper end of the auger 26 is also mounted to allow rotation and full support at least at each of the opposite ends of the auger 26. Activation of the drive unit 30 rotates the auger 26 thereby conveying the seed or grain 24 upwardly within the transport tube 12 toward the outlet opening 20. This activation may be controlled by the user in any suitable manner such as by wireless control or wired control, and may include on/off control of the auger 26 as well as variable speed control of the auger 26. The seed or grain 24 may be delivered or deposited from any suitable hopper, supply, cart, bin, etc., but is illustrated schematically as being delivered from a chute 40. As used herein, “downstream” refers generally to the direction from the inlet opening 14 toward the outlet opening 20 in the lengthwise axial direction of the transport tube 12. As used herein, “upstream” refers generally to the direction from the outlet opening 20 toward the inlet opening 14 in the lengthwise axial direction of the transport tube 12.

While the seed or grain may be transferred into any desired location from the outlet end of the transport tube 12, for illustrative purposes the flexible tube 22 is being used to fill seed containers 60 of an agricultural planting machine. For illustration, only a portion of the planting machine or equipment is shown in FIG. 1. The planting machine rides along wheels 62, and is conveyed along a field (not shown) during planting season in any desired manner.

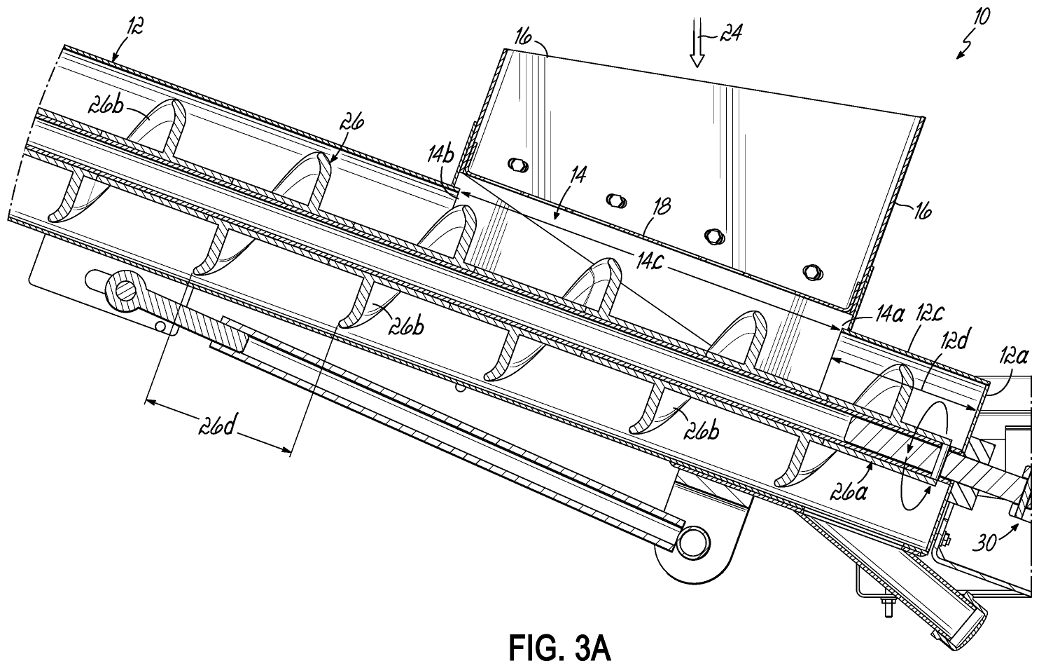

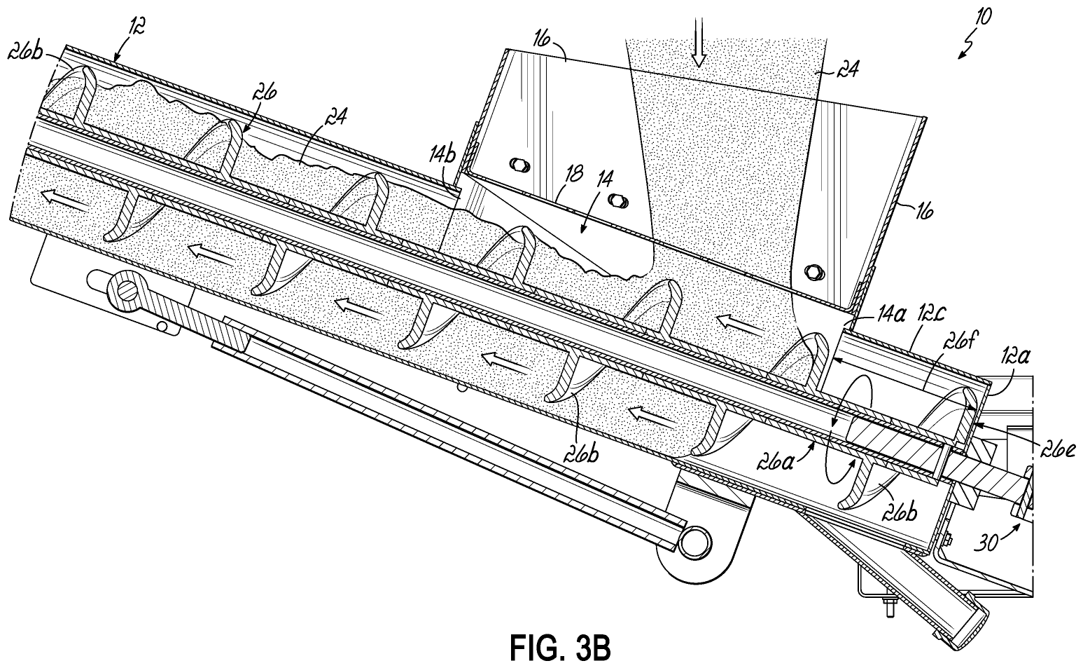

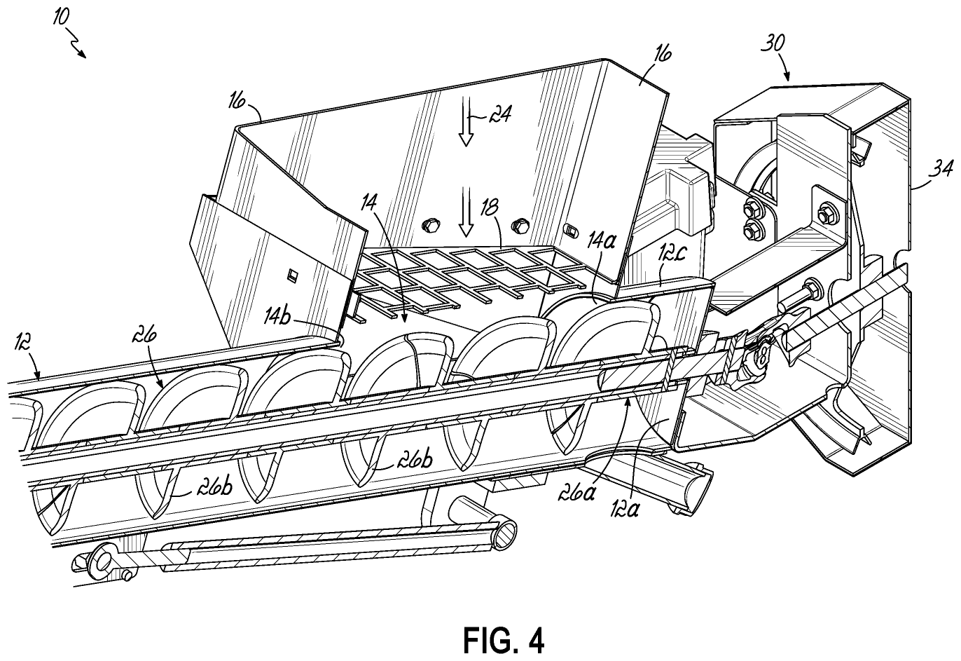

As best illustrated in FIGS. 3A, 3B, and 4 the inlet opening 14 extends along a lengthwise axis of the transport tube 12 and has an upstream, lower edge or end 14a and a downstream, upper edge or end 14b. The inlet opening 14 has an axial length 14c between the lower end 14a and the upper end 14b. An upstream portion 12c of the transport tube 12 extends between the lower end 14a of the inlet opening 14 and the lower end 12a of the transport tube. The upstream portion 12c has an axial length 12d between the lower end 12a of the transport tube 12 and the lower end 14a of the inlet opening 14. Accordingly, the inlet opening 14, and, more particularly, the lower end 14a of the inlet opening, is disposed at length 12d from the lower end 12a of the transport tube 12. Similarly, an upstream portion 26a of the auger 26 extends within the upstream portion 12c of the transport tube (e.g., between the lower end 14a of the inlet opening 14 and the upstream, lower end 26e of the auger) for an axial length 26f. As used herein, the “pitch” of the auger 26 refers to the length in the axial direction of one full blade 26b of the auger (i.e., a portion of the auger having one full 360-degree helix). Therefore, in embodiments having the lower end 26e of the auger 26 disposed at the lower end 12a of the transport tube 12, the relative lengths of length 12d of the upstream portion 12c of the transport tube and the pitch 26d of the auger determine the fraction of one auger blade 26b that is positioned between the lowermost end 14a of the inlet opening 14 and the lower end 12a of the transport tube 12. In other embodiments, the lower end 26e of the auger 26 may be positioned axially downstream from the lower end 12a of the transport tube 12, creating an axial gap between the lower end 26e of the auger and the lower end 12a of the transport tube. In such embodiments, the upstream portion 12c of the transport tube 12 may be lengthened so that the upstream portion 26a of the auger 26 (i.e., the portion within the upstream portion 12c of the transport tube) has the desired length.

The relative lengths of length 12d of the upstream portion 12c of the transport tube 12 (and/or the length 26f of the upstream portion 26a of the auger 26) and the pitch 26d of the auger affect the amount of seed or grain 24 that may be damaged during operation of the grain transferring device 10. For example, in a test operation utilizing a grain transferring device 10 having a variable length upstream portion 12c of the transport tube 12, a significant amount of seed was damaged when the length 12d of the upstream portion 12c was less than about ⅔ of the pitch 26d. The amount of seed damage decreased substantially as the length 12d of the upstream portion 12c was increased above about ⅔ of the pitch 26d. When the length 12d of the upstream portion 12c was about equal to the length of the pitch 26d, seed damage was nearly eliminated. Generally, increasing the length 12d of the upstream portion 12c beyond the length of the pitch 26d does not result in an appreciable, further reduction in seed damage. Accordingly, some exemplary embodiments according to at least some aspects of the present disclosure may include transport tube 12 upstream portions 12c having lengths 12d of at least about ⅔ of the pitch 26d, at least about 75% of the pitch 26d, at least about 90% of the pitch 26d, about equal to the length of the pitch 26d, or at least about equal to the length of the pitch 26d. Similarly, some exemplary embodiments according to at least some aspects of the present disclosure may include auger 26 upstream portions 26a having lengths 26f of at least about ⅔ of the pitch 26d, at least about 75% of the pitch 26d, at least about 90% of the pitch 26d, about equal to the length of the pitch 26d, or at least about equal to the length of the pitch 26d.

The length 14c of the inlet opening 14 extends along a length of the auger 26 that includes, for example, at least two auger blades 26b (e.g., at least about twice the pitch length 26d) and the inlet opening 14 is in the lower third portion of the length of the transport tube 12. As best illustrated in FIG. 2, the upper, opposite end or second end 26c of the auger 26 stops short of the outlet opening 20. That is, the outlet opening 20 is located downstream beyond the second end 26c of the auger 26.

As shown in FIGS. 3A and 3B, the outer diameter of each auger blade 26b is smaller than the inner diameter of the transport tube 12. Nevertheless, because the seed or grain is introduced into the auger at the inlet opening 14 which is disposed downstream from the end 26e of the auger 26 and because of the action of the auger blade 26 in pushing the seed or grain 24 upwardly toward the outlet end of the tube 12 and away from the lower end 12a, significant amounts of seed or grain do not fall by gravity or otherwise migrate to the lower end 12a of the transport tube 12. Accordingly, a very small amount (if any) of the seed or grain 24 is susceptible to damage at the lower end 12a of the transport tube 12 (e.g., between the rotating, upstream end 26e of the auger 26 and the stationary, lower end 12a of the transport tube 12) during the seed or grain transfer process.

Some embodiments may include an auger having a variable pitch (e.g., the pitch of the blades varies over the length of the auger). For such embodiments, the pitch for comparison to the various other lengths described herein may be the average pitch of the blades adjacent to the component having the length to which the pitch is compared. For example, when comparing the pitch length to the length of the upstream portion of the transport tube, the average pitch of the blades within the upstream portion of the transport tube may be used.

A method of transferring seed or grain 24 may be described generally as follows: 1) seed or grain 24 is delivered into a lower end portion of the transport tube 12 through an inlet opening 14, 2) the auger 26 is rotated using the drive unit 30 to move the seed or grain 24 from a location within the transport to 12 adjacent the inlet opening 14 toward the upper end of the transport tube 12, and 3) the seed or grain is directed through the outlet opening 20 proximate the upper end 12b of the transport tube 12 to the desired location, such as into containers 60 (FIG. 1). Because the inlet opening 14 is located substantially above the lower end 12a of the transport tube 12, a significant amount of seed or grain 24 is not trapped or caught at the lower end 26e of the auger 26 where it would be susceptible to damage.

A method of manufacturing an agricultural seed or grain transferring device may be described generally as follows: 1) constructing a transport tube 12 including an upstream, lower end 12a, a downstream, upper end 12b, an inlet opening 14 proximate the lower end, and an outlet opening 20 proximate the upper end; and 2) rotatably mounting an auger 26 within the transport tube 12, the auger including blades 26b having a pitch 26d length, the auger including an upstream portion 26a extending from an upstream, lower end 14a of the inlet opening to an upstream, lower end 26e of the auger, the upstream portion of the auger having an axial length 26f.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept. For example, any of the individual features or aspects described herein may be utilized alone or together in any combination depending on the desired results and attendant advantages.

What is claimed is:

1. An agricultural seed or grain transferring device, comprising:
a transport tube including an upstream, lower end and a downstream, upper end;
an auger mounted for rotation within the transport tube, the auger including blades having a pitch length; and
an inlet opening in the transport tube proximate the lower end of the transport tube and an outlet opening in the transport tube proximate the upper end of the transport tube;
wherein the auger includes an auger upstream portion extending from an upstream, lower end of the inlet opening to an upstream, lower end of the auger, the auger upstream portion having an auger upstream portion axial length.

2. The agricultural seed or grain transferring device of claim 1, wherein the auger upstream portion axial length is at least about ⅔ of the pitch length.

3. The agricultural seed or grain transferring device of claim 1, wherein the auger upstream portion axial length is at least about 75% of the pitch length.

4. The agricultural seed or grain transferring device of claim 1, wherein the auger upstream portion axial length is at least about 90% of the pitch length.

5. The agricultural seed or grain transferring device of claim 1, wherein the auger upstream portion axial length is about equal to the pitch length.

6. The agricultural seed or grain transferring device of claim 1, wherein the auger upstream portion axial length is at least about equal to the pitch length.

7. The agricultural seed or grain transferring device of claim 1, wherein the auger upstream portion is disposed within a transport tube upstream portion that extends from the upstream, lower end of the inlet opening to the lower end of the transport tube, the transport tube upstream portion having a transport tube upstream portion axial length.

8. The agricultural seed or grain transferring device of claim 7, wherein the transport tube upstream portion axial length is at least about ⅔ of the pitch length.

9. The agricultural seed or grain transferring device of claim 7, wherein the transport tube upstream portion axial length is at least about 90% of the pitch length.

10. The agricultural seed or grain transferring device of claim 1, wherein the inlet opening has an inlet opening axial length that is at least about twice the pitch length.

11. The agricultural seed or grain transferring device of claim 1, wherein the lower end of the auger is positioned at the lower end of the transport tube.

12. The agricultural seed or grain transferring device of claim 1, wherein the lower end of the transport tube is substantially closed.

13. The agricultural seed or grain transferring device of claim 1,
wherein the auger includes a second end located opposite to the lower end of the auger; and
wherein the outlet opening of the transport tube is located downstream beyond the second end of the auger.

14. The agricultural seed or grain transferring device of claim 1, wherein the transport tube is configured to be supported at an inclined angle.

15. The agricultural seed or grain transferring device of claim 1, further comprising a motorized drive unit coupled to the auger for rotating the auger.

16. The agricultural seed or grain transferring device of claim 15, wherein the motorized drive unit is driven by at least one of a hydraulic motor, an internal combustion engine, and an electric motor.

17. An agricultural seed or grain transferring device, comprising:
a transport tube including an upstream, lower end and a downstream, upper end;
an auger mounted for rotation within the transport tube, the auger including blades having a pitch length; and
an inlet opening in the transport tube proximate the lower end of the transport tube and an outlet opening in the transport tube proximate the upper end of the transport tube;
wherein the transport tube includes a transport tube upstream portion extending from an upstream, lower end of the inlet opening to the lower end of the transport tube, the transport tube upstream portion having a transport tube upstream portion axial length.

18. The agricultural seed or grain transferring device of claim 17, wherein transport tube upstream portion axial length is at least about ⅔ of the pitch length.

19. The agricultural seed or grain transferring device of claim 17, wherein the transport tube upstream portion axial length is at least about 90% of the pitch length.

20. The agricultural seed or grain transferring device of claim 17, wherein the transport tube upstream portion axial length is at least about equal to the pitch length.

21. The agricultural seed or grain transferring device of claim 17, wherein the auger includes an auger upstream portion extending within the transport tube upstream portion from the upstream, lower end of the inlet opening to an upstream, lower end of the auger, the auger upstream portion having an auger upstream portion axial length that is at least about ⅔ of the pitch length.

22. The agricultural seed or grain transferring device of claim 21, wherein the auger upstream portion axial length is at least about 90% of the pitch length.

23. The agricultural seed or grain transferring device of claim 21, wherein the auger upstream portion axial length is at least about equal to the pitch length.

24. A method of manufacturing an agricultural seed or grain transferring device, the method comprising:
constructing a transport tube including an upstream, lower end, a downstream, upper end, an inlet opening proximate the lower end, and an outlet opening proximate the upper end;
rotatably mounting an auger within the transport tube, the auger including blades having a pitch length, the auger including an auger upstream portion extending from an upstream, lower end of the inlet opening to an upstream, lower end of the auger, the auger upstream portion having an auger upstream portion axial length.

25. The method of claim 24, wherein the rotatably mounting the auger operation includes mounting the auger so that the auger upstream portion axial length is at least about ⅔ of the pitch length.

26. The method of claim 24, wherein the rotatably mounting the auger operation includes mounting the auger so that the auger upstream portion axial length is at least about 90% of the pitch length.

27. The method of claim 24, wherein the rotatably mounting the auger operation includes positioning the auger upstream portion within a transport tube upstream portion that extends from the upstream, lower end of the inlet opening to the lower end of the transport tube, the transport tube upstream portion having a transport tube upstream portion axial length.

28. The method of claim 27, wherein the rotatably mounting the auger operation includes positioning the auger upstream portion within the transport tube upstream portion, the transport tube upstream portion axial length being at least about ⅔ of the pitch length.

29. The method of claim 27, wherein the rotatably mounting the auger operation includes positioning the auger upstream portion within the transport tube upstream portion, the transport tube upstream portion axial length being at least about 90% of the pitch length.
